(19) United States
(12) Patent Application Publication
(10) Pub. No.: US 2012/0050021 A1
(43) Pub. Date: Mar. 1, 2012

(54) Method and Apparatus for In-Vehicle Presence Detection and Driver Alerting

(75) Inventors: Manoharprasad K. Rao, Novi, MI (US); Mark A. Cuddihy, New Boston, MI (US); Tai Luu, Westland, MI (US); Kwaku O. Prakah-Asante, Commerce Twp., MI (US)

(73) Assignee: FORD GLOBAL TECHNOLOGIES, LLC, Dearborn, MI (US)

(21) Appl. No.: 12/869,800

(22) Filed: Aug. 27, 2010

(51) Int. Cl. B60Q 1/00

(52) U.S. Cl. 340/425.5

(57) ABSTRACT

A method for alerting a driver of an automotive vehicle (or other responsible party) to the presence or inferred presence of an object, a person, or a pet animal in rear seating rows of the vehicle. The open/closed condition of rear vehicle doors is monitored to determine whether the driver may have placed an object, child, or pet in the rear seating rows prior to the start of a drive-cycle, and an alert is generated at the end of the drive-cycle to remind the driver to check the rear seat. Sound detection and analysis may also be used to identify sounds characteristic of a human (a young child, for example) or a non-human animal (a pet, for example) and thereby verify that a child or pet is present.

### BACKGROUND

1. Technical Field

The present invention relates to a method and system for alerting a driver (or other responsible party) to a situation where a human, a non-human animal, or an inanimate object may have been inadvertently left in the rear seating area of a parked vehicle.

2. Background Art

It is possible for an inattentive or distracted vehicle driver to unintentionally leave an infant, young child, or other person in a parked vehicle. To prevent such an occurrence, it is desirable to detect human occupancy in some or all of the vehicle seating positions, particularly in the rear seating row(s), and to provide an alert, reminder, and/or warning if the circumstances indicate that the driver may have inadvertently left an occupant behind in the parked vehicle.

Many different types of systems have been proposed to address this concern, including those that detect weight on a seat cushion, vision systems (using CMOS cameras, for example), vibration detection (using accelerometers), thermal systems, and capacitive sensing. These types of systems are feasible in theory, but they generally add considerable cost to the vehicle and so many consumers may opt not to pay the additional price of having an alerting system.

### SUMMARY

According to a disclosed embodiment, a method for alerting a responsible party to a possibility of an object or person being present in a passenger cabin of a vehicle comprises detecting a first opening of a rear passenger door of the vehicle, monitoring at least one vehicle system to detect a drive-cycle end, and generating an alert for the responsible party when the drive-cycle end is detected.

According to another embodiment, a method comprises detecting a first opening of a rear passenger door of the vehicle, monitoring an ON/OFF condition of a vehicle powertrain to detect a drive-cycle end, generating an audible alert for the responsible party when the drive-cycle end is detected, and terminating the alert after a second opening of the rear passenger door is detected.

According to another embodiment of the invention, a method for alerting a responsible party to a possibility of an object being present in a passenger cabin of a vehicle comprises detecting sound in the passenger cabin, analyzing the detected sound to determine whether it is characteristic of vocal sounds make by a human or non-human animal, monitoring a vehicle system to detect a drive-cycle end, and generating an alert when it is determined the detected sound indicates the presence of a human or non-human animal and the drive-cycle end is detected.

### BRIEF DESCRIPTION OF THE DRAWINGS

The present invention will hereinafter be further explained by means of non-limiting examples with reference to the appended Figures where;

FIG. 1 is a schematic top view of a vehicle equipped with a system for detecting and or inferring occupant detection,

FIG. 2 is simplified schematic block diagram of an embodiment of an occupant detection system,

FIG. 3 is simplified schematic block diagram of an embodiment of a motion processor that may be used in an occupant detection system,

FIG. 4 is simplified schematic block diagram of an embodiment of a sound processor that may be used in conjunction with the invention,

FIG. 5 is a flow diagram for an occupant alerting algorithm,

FIG. 6 is a flow diagram for an alerting algorithm according to another embodiment of the invention, and

FIGS. 7-9 are a flow diagram for an alerting algorithm according to yet another embodiment of the invention.

It should be noted that the drawings have not necessarily been drawn to scale and that the dimensions of certain features may have been exaggerated for the sake of clarity.

### DETAILED DESCRIPTION

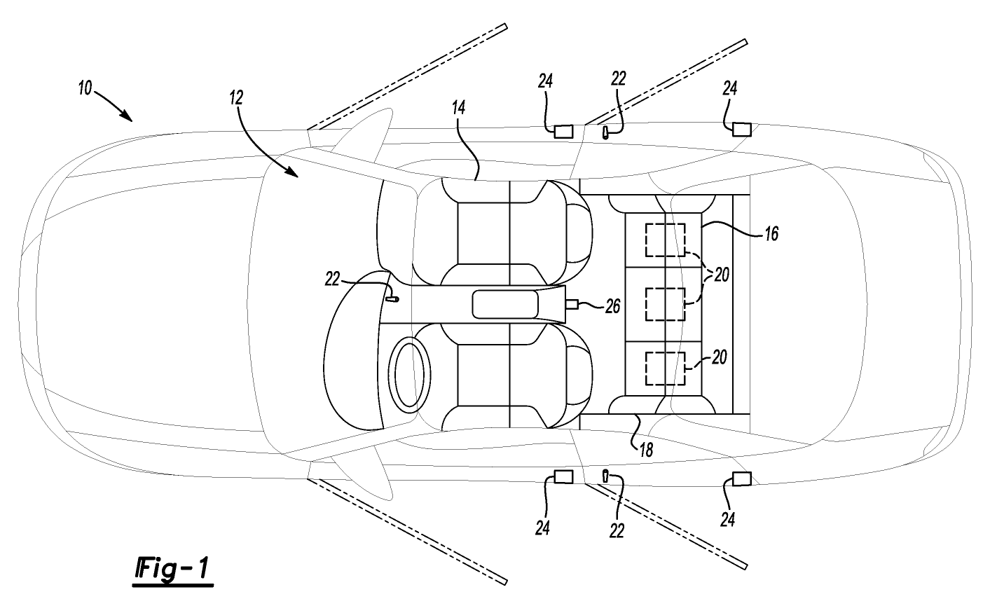

FIG. 1 shows a vehicle 10 comprising a passenger compartment 12 having a front seating row 14 and a rear seating row 16. The rear seating row is shown to comprise a bench seat 18 extending across the width of the passenger compartment. Three vibration sensors 20 are arrayed across the bench seat in positions which generally correspond to the three defined seating positions of the seat. The defined seating positions may coincide with seating surface contours and/or the presence of occupant restraint belts (not shown).

Vibration sensors 20 are preferably generally flat and flexible enough that they may be integrated into the seat bottom without impairing the comfort of the seat. They may be disposed atop the surface of the seat bottom or may be embedded some distance below the surface of the seat bottom. Alternatively or in addition to being in or on the seat bottom, vibration sensors 20 may be provided elsewhere in relation to one of more defined seating position, for example in the seat back portion of the bench seat. Vibration sensors 20 should be located so as to be effective in detecting vibrations produced by an infant or small child that is secured in a baby/child seat that is in turn secured within the vehicle in a defined seating position.

A known type of vibration sensor suitable for use in the present invention is a flexible electret sensing mat. Such sensors comprise a pair of thin, sheet-like electrodes separated by a polymer (such as polypropylene) film that contains electrically charged pockets. The mat generates a small electric charge when subjected to compression or expansion. They are extremely sensitive to vibrations, and are capable of reliably detecting vibrations of extremely small magnitude, such as those caused by a human heartbeat. It is alternatively possible to employ a single vibration sensor of sufficient size and sensitivity to detect vibrations caused by an occupant located in or near any of the seating positions of rear seating row.

It is to be understood that the present invention may be practiced in relation to a passenger vehicle having any number of seating rows and/or seating positions, and that the example vehicle configuration shown in FIG. 1 is used merely for convenience of description.

One or more microphones 22 are disposed within the passenger compartment. Two or more microphones 22 that are spaced from one another may be used if it is desired to provide the capability of determining a location of origin of a sound, as is described in more detail below.

One or more of the microphones 22 may be utilized in a vehicle occupant communication system. For example, a hands-free telecommunication and/or voice-recognition control system (such as SYNC®) may utilize a microphone located near the driver/operator of the vehicle.

Door condition sensors 24 are provided for each passenger compartment door, the sensors outputting signals indicating whether their respective door is open or closed. A temperature sensor 26 may also be provided to monitor ambient temperature within the passenger compartment.

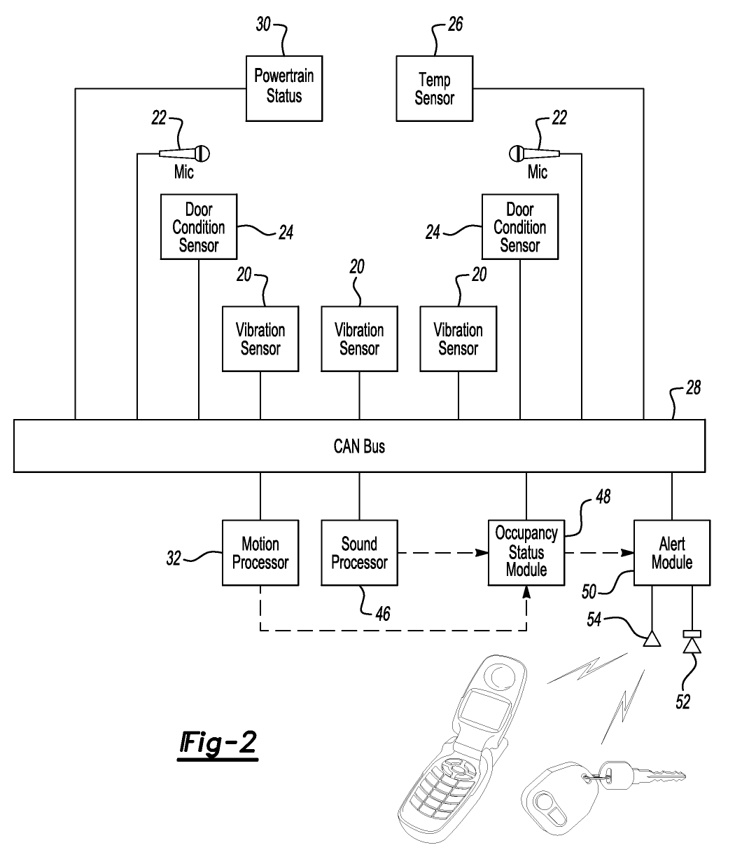

Referring now to FIG. 2, a simplified schematic block diagram shows an embodiment of the system in which an vehicle electronic communication network, for example a CAN bus 28, is used to achieve communication between the various components. Vibration sensors 20 output signals related to any sensed movement at their respective seating positions. Microphones 22 output signals related to sounds sensed in the passenger compartment.

Powertrain status sensors (PSS) 30 monitor one or more indicia of the condition of a vehicle powertrain that indicate whether the vehicle is in a driving mode or a parking mode. For example, for a vehicle powered by an internal combustion engine (ICE) a PSS 30 may monitor the ON/OFF status of an ignition switch or a master power switch (not shown) and/or the PARK/DRIVE status of a transmission. For a vehicle powered partially or solely by an electric motor, the PSS may monitor the ON/OFF status of a master power switch for the traction motor and/or transmission status. In any case, the outputs signals from PSS 30 allow determination of whether the vehicle powertrain is in a power-off condition indicating that the vehicle may be considered to be parked, or in a power-on condition indicating that the vehicle may be considered to be driving or will soon be driving.

Signals output by all of the sensors are transmitted over CAN bus 28 utilizing a high-speed communication protocol, as is well known in the art, by means of which those signals may be received by any other component connected with the bus. In an alternate embodiment of the invention, the vibration sensors 20 may be directly connected to motion processor to reduce the transmission needs of the communication network.

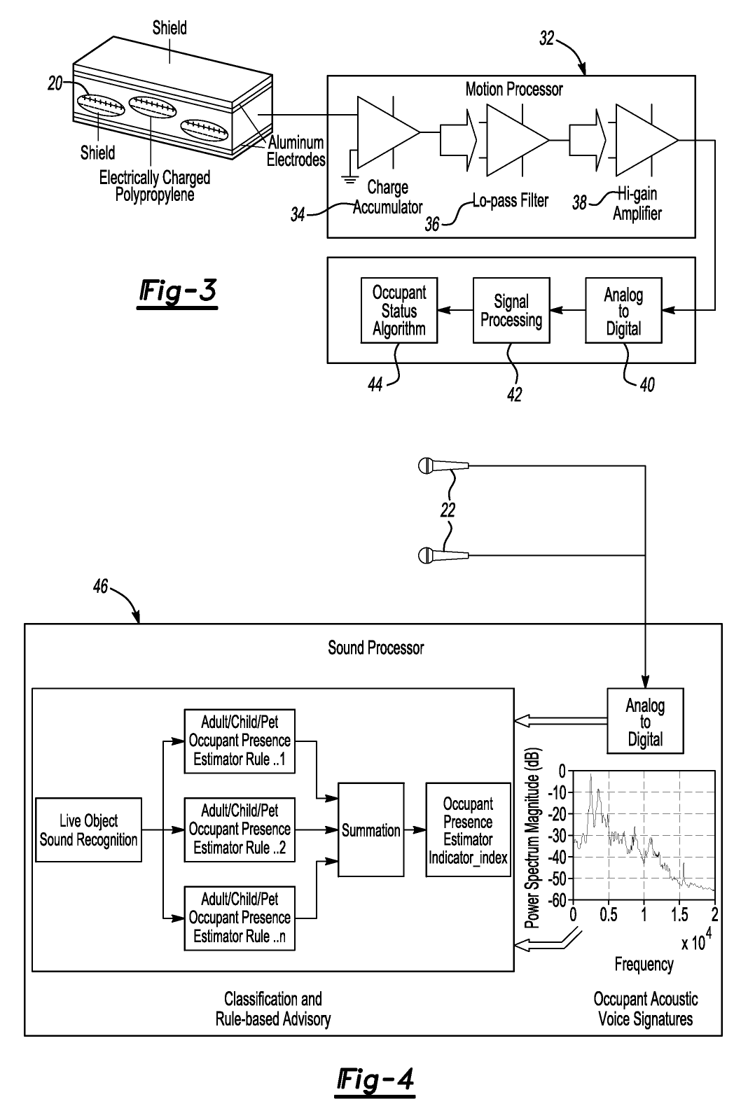

Motion processor 32 receives electrical signals output by the vibration sensor(s) 20 and processes those signals as necessary to determine whether any detected vibration is caused by a human being in any of the seating positions. FIG. 3 is a schematic diagram of one possible embodiment of a motion processor 32. Electrical signals generated by vibration sensors 20 are sent to a signal conditioner which includes a charge accumulator 34, a low-pass filter 36, and a high-gain amplifier 38. Such processing steps may be necessary to discriminate between seat occupant motion (voluntary or involuntary) and other extraneous vibrations caused, for example, by the vehicle moving over a road surface or the parked vehicle being moved by the wind. The signal is passed to an analog-to-digital converter 40 and, if necessary, additional signal processing 42 may be performed before the signal is analyzed by an occupant status algorithm 44. The occupant status algorithm 44 determines which of the seating positions is occupied by a human, and this output is transferred to CAN bus 28 as necessary for subsequent steps in the process. The seat occupancy determination may be expressed in various ways, such as a probability, a percent certainty, and/or a value usable by a fuzzy logic process.

Referring now to FIG. 4, a schematic diagram of one possible embodiment of a sound processor 46 is depicted. Sound processor 46 receives signals output by the one or more microphones 22 and processes those signals as necessary to determine whether any detected sound is caused by a human or animal (such as a family pet) occupant in the passenger compartment. Such processing steps may include filtering, amplifying, and/or analog-to-digital conversion of the output signals. The sound is transferred to a microprocessor, either contained within the existing SYNC system or a separate, external module for processing. First, the signal is converted into digital data for processing by a microprocessor. Frequency domain and time domain acoustic signatures of occupants are obtained in real-time and then sent to a rule-based classification algorithm for detection decision-making. If two or more microphones are utilized, acoustic data received at the separate microphones may be processed to determine a location of origin of a sound. For example, the different times-of-arrival of a sound at different microphones may be used to calculate the origin of the sound using triangulation. Other acoustic features, as characterized by the microphone output signals, may also be used, such as phase shifts.

Sound processor 46 may also perform processing steps that involve matching the sounds received by microphone(s) 22 with known and/or stored acoustic voice signatures of occupant voices. For example, frequency domain and time domain acoustic signatures of occupant voices may be obtained during a particular vehicle trip or over a greater length of time. Pitch, spectral moments, cepstral coefficients and other appropriate digital sound signal processing parameters extracted from the voice signals may be used in signal analysis. The acoustic voice signal analysis outcomes are used in a rule-based classification algorithm to identify the voices of specific occupants, for example family members that use the vehicle frequently, for occupant detection decision-making. Sound processor 46 may employ neural networks to perform the required signal analysis and rule-based classification, as disclosed more fully in U.S. Pat. No. 7,353,088 B2, the disclosure of which is incorporated herein by reference.

It should be understood that the term “voice,” as used herein, includes any vocal sound made by a human or other animal, to include any sounds that may be made by infants, such as crying, and by pet animals (dogs, cats, birds, etc.) even if those sounds may not meet a formal definition of “speech.”

The post-processing output of sound processor 46 should at least be a determination of whether or not a human- or animal-made sound has been detected in the passenger compartment. The output may further include the location of origin of one or more sounds and/or any correlation between a detected voice and a known/stored acoustic speech signature.

An occupant status module (OSM) 48 receives the signals output by motion processor 32 and sound processor 46 through either CAN bus 28 or a direct communication link as indicated by the dashed lines shown in FIG. 2. OSM 48 interprets the vibration and acoustic data contained in the sensor signals to determine, to a high degree of certainly, whether an occupant is present in the seating positions being monitored. It is also possible for OSM 48, given adequate sensor data, to determine the number and/or location of any occupants present in the vehicle. These determinations may be accomplished by means of context-based aggregation and combinational logic, in a manner well known in the art.

An alerting module 50 receives seat occupancy outputs from OSM 48, either through CAN bus 28 or through a direct electrical connection as indicated by the dashed line in FIG. 2. Alerting module 50 and/or OSM 48 also receive signals from door condition sensors 24 and powertrain status sensor 30 as further inputs to a alerting logic algorithm which determines if the driver or other responsible party should be notified of an occupant present in the vehicle after the vehicle is stopped and the doors are closed, indicating that the driver intends to leave the parked vehicle.

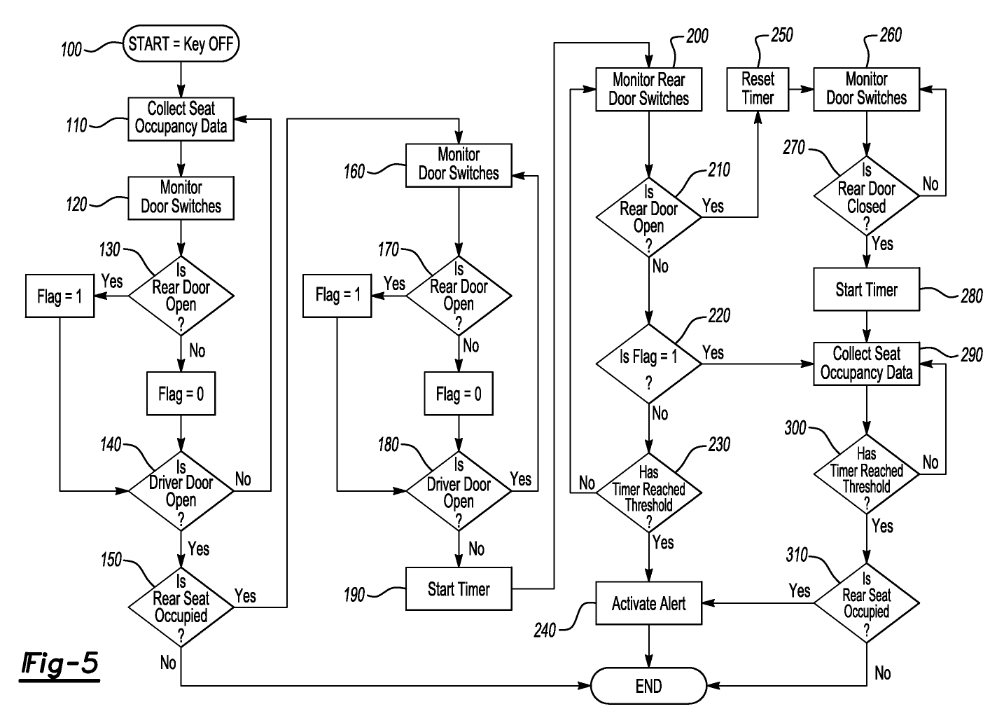

A flow diagram for such an alerting algorithm is shown in FIG. 5. In the algorithm it is assumed that occupancy monitoring is performed only for rear seating positions; however the same monitoring can be performed for front seat positions assuming the correct sensors are provided.

The algorithm starts at block 100 with the vehicle ignition “OFF,” (or an equivalent condition, depending on the type of powertrain present in the vehicle) indicating that the vehicle is parked. Seat occupancy information for the seat(s) being monitored is collected from the vibration sensors 20 and microphones 22 at block 110. It should be noted that the vibration sensors 20 and microphones 22 may be utilized while the vehicle is operating (prior to being parked) to provide occupancy data to other vehicle systems, such as an occupant safety system or an entertainment system.

The system monitors door condition sensors 24 (120). First, the system sets a flag=1 if a rear door is open (130, YES), then checks whether the driver's door is open (140). If the driver's door has not yet been opened, the method returns to block 110.

Once the driver's door is determined to be open (140, YES), rear seat occupancy is checked (150). If NO, the routine ends. If the rear seat is occupied, door switches are again monitored (160) with a flag=1 set if a rear door is open (170). If the driver's door remains open (180, YES) the method returns to block 160. When the driver's door is closed (indicating that the driver has left the vehicle), a timer is started at block 190. The rear doors are then monitored (200) and if no rear door is open (210, NO) the flag value is checked (220). If flag=0 the timer is checked to see whether a threshold time has elapsed (230). The threshold time is selected to give the driver sufficient time to exit the vehicle, open a rear door, and assist a rear seat occupant out of the vehicle. When the threshold time has elapsed without the rear door being opened (230, YES), the alert is activated at 240. If the rear door is opened prior to the threshold time having elapsed (210, YES), the timer is reset to zero (250). The rear door switches are checked again at 260 and when the rear doors are closed (270, YES) the timer is started (280). Rear seating row occupancy is checked again (290) and when the threshold time has elapsed (300, YES), if the rear seats are occupied (310, YES) the alert is activated (240).

The alert may be in any form that will inform the driver or other responsible person of the rear seating row occupancy condition. The alert may be an audible signal produced by a vehicle-mounted speaker 52, or an antenna 54 may be used to transmit the alert to a receiving device (key fob, cell phone, Personal Digital Assistant (PDA), etc.) carried by the driver. If desired, a responsible person, service, or agency other than the driver may be alerted by a cell phone call, text message, or other means of wireless communication.

The alerts generated may escalate in frequency and/or intensity until the alerted party has responded in an adequate manner, such as by returning to the vehicle and opening a vehicle door. The alerts may also escalate in depending upon the ambient temperature detected by temperature sensor, with uncomfortably hot or cold temperatures calling for more frequent and/or more intense alerts.

In alternative embodiments, a vehicle equipped with less than all of the sensors and related hardware depicted in FIGS. 1 and 2 may employ a simplified method to provide alerts to a driver or other responsible party if the presence of an inanimate object and/or a living being (a human or a pet animal) is detected (or inferred) in the rear seating row(s) 16. For example, most relatively inexpensive passenger vehicles are equipped with door condition sensors 24 to provide “door ajar” alerts to the driver and/or other responsible party in the vehicle. Relatively inexpensive vehicles generally do not, however, include purpose-specific presence detection equipment such as vibration sensors 20, microphones 22, or temperature sensor 26. It would be advantageous to provide the operator of such a less-expensive vehicle with alerts or reminders when it is likely that an object, and possibly a human or a pet animal, is in the rear seating row at the end of a drive-cycle.

In this context, a drive-cycle is defined as the sequence beginning when one or more vehicle systems are activated which indicate that a vehicle operator has transitioned (or intends to transition shortly) from a parked condition to a driving condition, and ending when some vehicle system/systems is/are actuated (activated and/or deactivated) which indicate a transition back to the parked condition. There are many vehicle systems that may be monitored to indicate the start and end of a drive-cycle, such as ignition switch condition for an ICE-powered vehicle, a master power switch for the traction motor of an electric vehicle, transmission state, and/or drivers door open/closed condition.

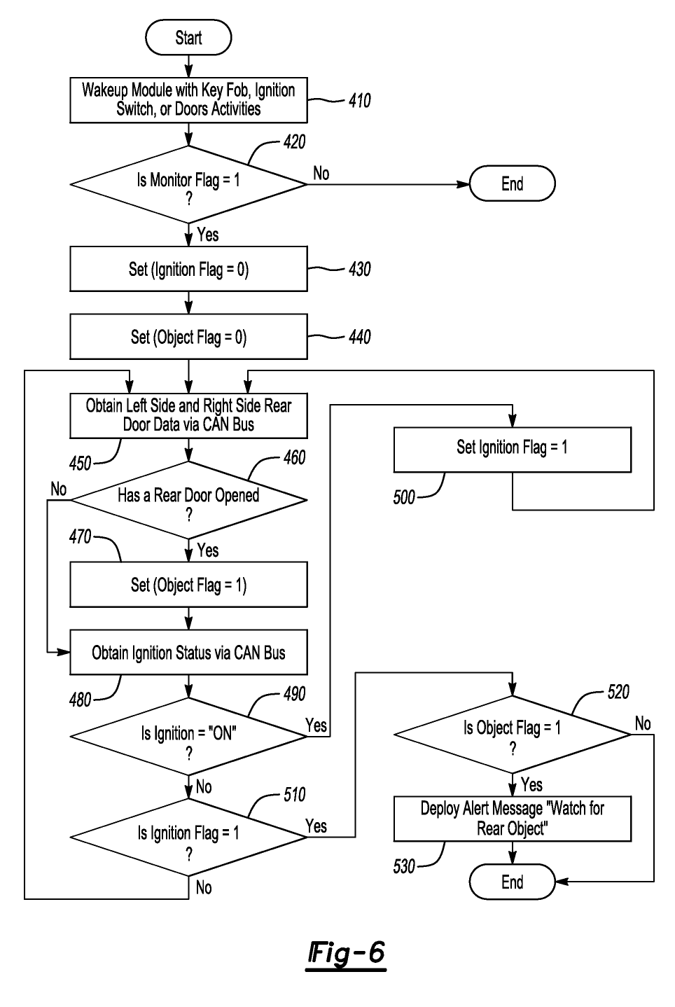

FIG. 6 shows a method wherein only inputs from door condition sensors 24 and powertrain status sensor(s) 30 are utilized. In this method, the presence of an object in the rear seating rows is inferred from an opening/closing of a rear door.

At block 410 an electronic module implementing the method is activated, or “woken up,” by a user action such as actuating a switch on a remote control device (key fob), opening a car door, or inserting a key into an ignition switch. At block 420, a check is made of whether or not the alerting system is activated (if desired, the vehicle operator may be given the option to deactivate the system), with Monitor Flag=1 meaning that the system is activated. If YES at block 420, variables are initialized at blocks 430-440 as shown: Ignition_Flag=0 indicates ignition system/switch is OFF, and Object_Flag=0 indicating that no object alert condition exists yet.

At block 450, open/closed status of applicable vehicle doors is obtained, such as via a CAN bus. If a rear door is indicated to have been opened (block 460, YES), Object_Flag=1 is set at block 470. Object_Flag=1 indicates that some object is assumed to have been placed in the rear seating row when the rear door was opened prior to the start of a drive-cycle.

At block 480 the current condition of the ignition system is obtained, such as via a CAN bus. At block 490, the ignition condition is read and, if the ignition switch is set to ON, Ignition_Flag=1 is set at block 500. The method cycles back to block 450 and Ignition_Flag=1 remains so long as the ignition condition remains ON.

If at block 490 the ignition condition is OFF, the method advances to block 510 where Ignition_Flag is read. If Ignition Flag=1 (meaning that the ignition switch was previously detected to be ON), the method advances to block 520 and the Object Flag is checked. As may be seen from examining the logic steps of blocks 450-510, the conditions of the vehicle doors and the ignition system/switch are continuously monitored with the result being that at the time the ignition status changes from ON to OFF (indicating that the drive-cycle has ended) if Object_Flag=1 (indicating that a rear door was previously opened), an alert message “WATCH FOR REAR OBJECT” is generated (block 530).

The functionality described above provides a low-cost, “software only” solution for rear seat object alerting in a vehicle that is equipped with door condition sensors.

In the foregoing method, it is to be understood that the use of the ignition system is by way of example only, and other appropriate systems may be used to indicate the start and end of a drive-cycle, as discussed above.

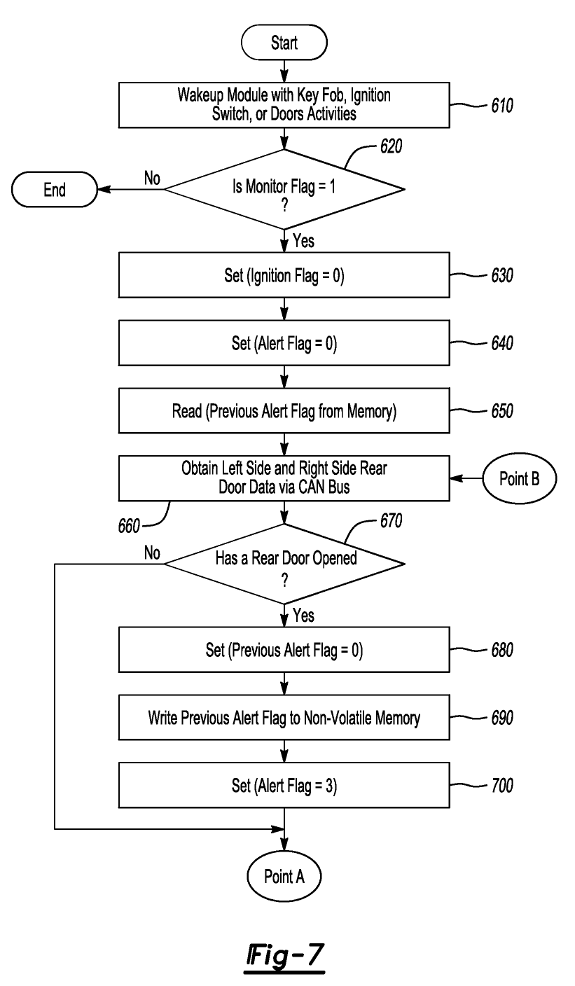

Another embodiment of a simplified method, depicted as a logic flow chart in FIGS. 7-9, may be implemented in a vehicle in which one or more microphones 22 are utilized in addition to door condition sensors 24 and PSS 30. A microphone may be present in a vehicle for use in a hands-free phone system or a voice command system, so that the following method may be implemented without adding any hardware that is specific to the alerting system.

In this embodiment, digital processing of signals output by microphone(s) 22 is used to determine whether any detected sound is characteristic of sounds made by a human or a pet animal. As described above in relation to FIG. 4, such processing steps may include filtering, amplifying, analog-to-digital conversion, frequency domain and time domain analysis, and/or rule-based classification algorithms. Any known method of signal processing may be used that will reliably identify and/or classify detected sounds.

The sound processing may primarily focus on identifying non-speech sounds made by a person or animal, since a person that is unable to speak may be assumed to be less likely to be able to alert the driver herself/himself, and so be most in need of such an alerting system. Such non-speech sounds may include those that may be made by a young child or a disabled adult that is not able to speak, and/or those made by animals.

In the method of FIGS. 7-9, at block 610 an electronic module implementing the method is activated, or “woken up,” by a user action such as actuating a switch on a remote control device (key fob), opening a car door, or inserting a key into an ignition switch. At block 620, a check is made of whether or not the alerting system is activated (if desired, the vehicle operator may be given the option to deactivate the system), with Monitor Flag=1 meaning that the system is activated. If YES at block 620, variables are initialized at blocks 630-640 as shown: Ignition_Flag=0 indicates ignition system/switch is OFF, and Alert_Flag=0 indicating that no alert condition exists yet.

At block 650, a Previous_Alert_Flag that may be stored in non-volatile memory is read. This allows an alert to carry over from a previous drive-cycle rather than being cleared. If no carry-over alert is desired, block 650 and others blocks referring to the Previous_Alert_Flag may be completely eliminated from the routine, or the vehicle operator may be given the option to temporarily and reversibly disable those steps.

At block 660, open/closed status of applicable vehicle doors is obtained, such as via a CAN bus. If a rear door is indicated to have been opened (block 670, YES), Previous_Alert_Flag=0 is set (if the alert carry-over function is desired) at block 680, and this is written to non-volatile memory at block 690.

Alert_Flag=3 is set at block 700, indicating that some object (not necessarily a child or pet animal) is assumed to have been placed in the rear seating row when the rear door was opened prior to the start of a drive-cycle.

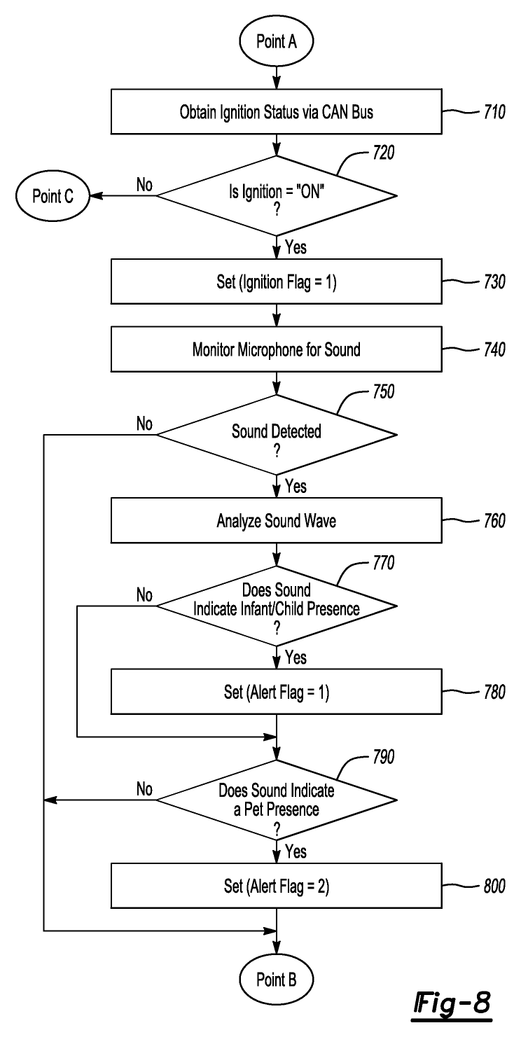

Progressing to block 710 (see FIG. 8), the current condition of the ignition system is obtained, such as via a CAN bus. At block 720, the ignition condition is read, and Ignition_Flag=1 is set at block 730 if that condition is ON.

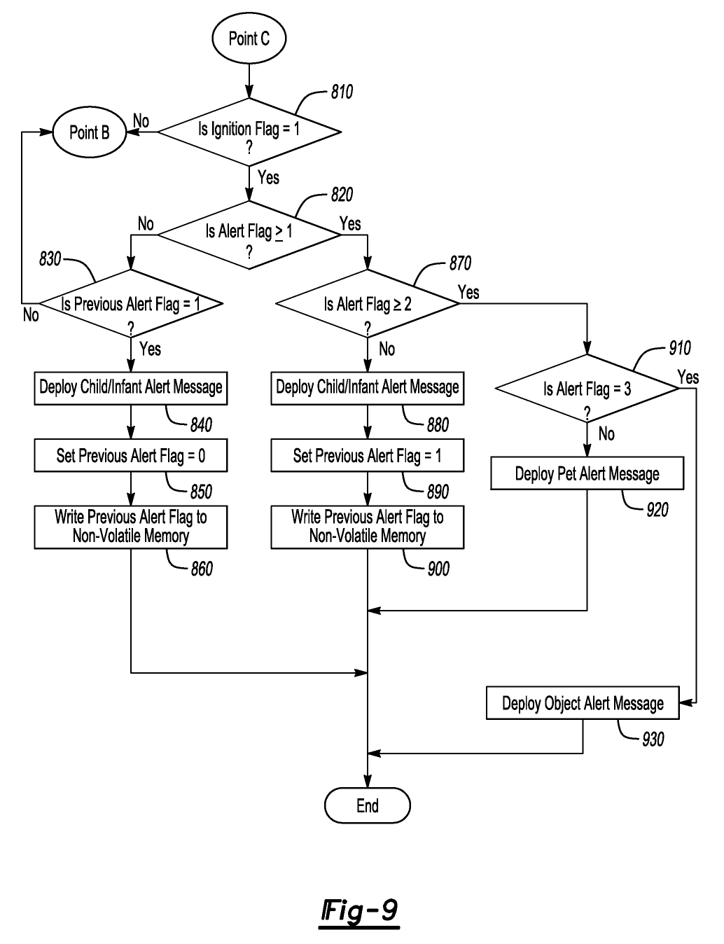

If the ignition condition is OFF at block 720, the method progresses to block 810 (see FIG. 9) where Ignition_Flag is evaluated: If Ignition_Flag=0, the drive-cycle has not yet begun, and the method returns to block 660. If Ignition_Flag=1, the drive-cycle has been completed, and the logic of steps 820 and those that follow will execute, which will be described below.

When at block 720 the ignition condition is ON, Ignition_Flag=1 is set (block 730) and the method advances to block 740 where one or more microphones in the passenger cabin are monitored. If any sound is detected at block 750 (YES), the signals are analyzed (using appropriate signal processing) at block 760. If the analysis determines that the sounds are characteristic of those likely to be made by a child (block 770, YES) Alert_Flag=1 is set at block 780. The sound processor may also be programmed to identify non-human animal noises that may be made by a pet animal at block 790, and if such sounds are indicated Alert_Flag=2 is set at block 800.

The method next returns to block 660 and cycles through the steps so that the conditions of the vehicle door, the ignition system/switch, and the microphone(s) are continuously monitored, until at blocks 720 and 810 the ignition status is OFF and Ignition_Flag=1, indicating that a drive-cycle has been completed. Once those two conditions are met, the Alert_Flag value is read and alert messages are deployed as appropriate in accordance with the logic shown in blocks 820-930. As may be seen from those blocks, one of the following four alert conditions will exist:

a) If Alert_Flag=1 the method reaches block 880 and an alert message is deployed or generated to inform the driver (or other responsible party) that a child or infant may be present. Previous_Alert_Flag is also set to 1 (block 890) and written to non-volatile memory (block 900), so that the alert condition will still be active in a subsequent drive cycle if the rear door is not opened.

b) If Alert_Flag=2 (pet sound detected, rear door has been opened and closed) the method reaches block 920 and an alert is generated to inform the driver (or other responsible party) that a pet may be present in the vehicle.

c) If Alert_Flag=3 (no child or pet sound detected, and rear door has been opened and closed during drive cycle) the method advances to block 930 and an “object alert” is generated.

d) If Alert_Flag=0, but Previous_Alert_Flag=1 (having been set at block 900 in a previous drive cycle and not cleared by a subsequent door opening), a child/infant alert message is generated at block 840. Blocks 850 and 860 ensure that the child/infant alert is active for one additional drive cycle only.

The functionality described above provides a “software only” solution for object/passenger alerting in a vehicle that is equipped with door condition sensors and a microphone. The method provides both a) a sound monitoring feature that is effective if a person or a pet animal makes detectable and classifiable sound, and b) door open/closed monitoring (similar to that described above in relation to FIG. 6) to infer the presence in the rear seat of what may be a silent human or pet or an inanimate object.

In the foregoing method, it is to be understood that the use of the ignition system is by way of example only, and other appropriate systems may be used to indicate the start and end of a drive-cycle, as discussed above.

In the methods described above, the alerts may be terminated by an appropriate driver action or by a combination of actions and/or system conditions, such as the driver activating a switch, giving an appropriate command to a voice-recognition control system, and/or opening a rear door.

While the best mode for carrying out the invention has been described in detail, those familiar with the art to which this invention relates will recognize various alternative designs and embodiments for practicing the invention as defined by the following claims.

What is claimed:

1. A method for alerting a responsible party to a possibility of an object or person being present in a passenger cabin of a vehicle comprising:
detecting a first opening of a rear passenger door of the vehicle;
monitoring a vehicle system to detect a drive-cycle end; and
generating an alert for the responsible party when the drive-cycle end is detected.

2. The method according to claim 1 wherein the vehicle system is a vehicle powertrain and the drive-cycle end is indicated by a power-off condition.

3. The method according to claim 2 wherein the power-off condition is an off condition of an ignition system of an internal combustion engine.

4. The method according to claim 1 wherein the vehicle system is a door condition monitor sensor.

5. The method according to claim 1 further comprising terminating the alert after a second opening of the rear passenger door is detected.

6. The method according to claim 1 wherein the alert comprises an audible signal.

7. The method according to claim 1 wherein a module implementing the method is activated by a user action comprising at least one of an actuating a switch on a remote control device, opening a vehicle door, and inserting a key into an ignition switch.

8. The method according to claim 1 further comprising setting a carry-over flag to activate an alert after a subsequent drive-cycle.

9. The method according to claim 1 further comprising:
detecting sound in the passenger cabin;
analyzing the detected sound to determine whether it is characteristic of sounds make by a human or non-human animal; and
generating a specific alert when it is determined the detected sound indicates the presence of a human or non-human animal and the drive-cycle end is detected.

10. A method for alerting a responsible party to a possibility of an object or person being present in a passenger cabin of a vehicle comprising:
detecting a first opening of a rear passenger door of the vehicle;
monitoring an ON/OFF condition of a vehicle powertrain to detect a drive-cycle end;
generating an audible alert for the responsible party when the drive-cycle end is detected; and
terminating the alert after a second opening of the rear passenger door is detected.

11. A method for alerting a responsible party to a possibility of an object being present in a passenger cabin of a vehicle comprising:
detecting sound in the passenger cabin;
analyzing the detected sound to determine whether it is characteristic of vocal sounds make by a human or non-human animal;
monitoring a vehicle system to detect a drive-cycle end; and
generating an alert when it is determined the detected sound indicates the presence of a human or non-human animal and the drive-cycle end is detected.

12. The method according to claim 11 wherein the step of detecting sound begins after detection of an ON condition of the vehicle ignition system.

13. The method of claim 11, wherein the step of detecting sound is performed by a microphone that serves as a component of a vehicle occupant communication system.

14. The method of claim 11, wherein the step of analyzing the detected sound is accomplished at least in part by a neural network trained to identify vocal patterns.

15. The method according to claim 11 wherein the vehicle system is a vehicle powertrain and the drive-cycle end is indicated by a power-off condition.

16. The method according to claim 15 wherein the power-off condition is an off condition of an ignition system of an internal combustion engine.

17. The method according to claim 11 wherein the vehicle system is a door condition monitor sensor.

18. The method according to claim 11 further comprising terminating the alert after a second opening of the rear passenger door is detected.

19. The method according to claim 11 wherein the alert comprises an audible signal.

20. The method according to claim 11 wherein a module implementing the method is activated by a user action comprising at least one of an actuating a switch on a remote control device, opening a vehicle door, and inserting a key into an ignition switch.
